(19) United States
(12) Patent Application Publication
(10) Pub. No.: US 2024/0298396 A1
(43) Pub. Date: Sep. 5, 2024

(54) A LIGHTING DEVICE

(71) Applicant: SIGNIFY HOLDING B.V., EINDHOVEN (NL)

(72) Inventors: HENRICUS MATHIJS MARIA CREEMERS, EINDHOVEN (NL); RONALD JOHANNES GELTEN, GELDRIOP (NL); GUIDO THEO MARIA LAMERICHS, HOESELT (BE)

(21) Appl. No.: 18/566,172

(22) PCT Filed: Jun. 2, 2022
(86) PCT No.: PCT/EP2022/065068

§ 371 Date: Dec. 1, 2023

(30) Foreign Application Priority Data
Jun. 3, 2021 (EP) 21177549.9

(51) Int. Cl. H05B 47/19; H04B 1/38

(52) U.S. Cl. CPC H05B 47/19; H04B 1/38

(57) ABSTRACT

A lighting device (300) comprising a potted wireless communication module (100) as an integral part of the lighting device (300). The wireless communication module (100) comprises a wireless communication unit transmitting and/or receiving a radio wave of a frequency range from 6 GHz to 300 GHz.

### FIELD OF THE INVENTION

The present invention relates to a lighting device comprising a wireless communication module as an integral part of the lighting device. Specifically, the wireless communication module is a potted wireless communication module configured to transmit and/or receive high frequency radio signals.

### BACKGROUND OF THE INVENTION

Along with the development of the mobile telecommunication technologies, the user data consumption has grown rapidly in the last decade. Thus, a higher download and upload speed and a greater bandwidth are needed to meet the user requirements. Wireless connectivity standards and specifications that accommodate these growing needs are driven by bodies such as 3GPP and IEEE. Among the general audience the 3GPP telecommunication standards of 2G, 3G, 4G and 5G are most commonly known. An important aspect of the 5G standard is that higher radio frequencies are used. While the 4G-LTE frequencies range from 700 MHZ-2.7 GHz, 5G frequencies are provided in two sets: wherein the first set ranges from 450 MHz to 6 GHz and the second set ranges from 24.25 GHz to 52.6 GHz. Generally speaking, the band of radio frequencies in the electromagnetic spectrum from 30 to 300 GHz is called Extremely high frequency (EHF). Since the radio waves in this EHF band have wavelengths in the order of millimeters, EHF band is also called millimeter band and the radio wave of this band is called millimeter wave, or mmWave. However, the term “mmWave” has been given different definitions in the field in terms of frequencies.

A typical mmWave communication device comprises a baseband section for providing different function, such as a power supply function, an interfacing function, a data storage function, and a data processing function, and one or more radio frequency (RF) sections each comprising a transmitter and/or a receiver. The transmitter and/or receiver need to connect to an antenna for transmitting and/or receiving a radio wave. Typically, for frequencies above 6 GHz, physical separation between the radio frequency sections and the antenna should be minimized due to excessive signal losses in the cables.

The baseband section and the RF section(s) can be arranged as a single module or different modules. In order to secure a reliable operation of the mmWave communication device, these sections need to be mechanically secured, e.g., by brackets, to against vibrations and impact.

The typical mmWave communication device also comprises cooling sections, e.g., a heat sink for transferring dissipated heat of the device to a cooling medium (typically air), an internal heat spreader and/or a thermal pad for transferring heat from an internal heat source (e.g., a processor) to the heat sink. The heat sink is normally made of metal, such as aluminum or copper, and is provided with a large surface area, e.g. by fins, in contact with the cooling medium.

Since the typical mmWave communication device is designed for outdoor environment, it needs to resist moisture, water, dust, etc., by weatherproofing methods, e.g., by providing a waterproofing encapsulation housing, by providing sealings for cable feedthroughs and connectors, and/or by providing separated compartments for different sections.

All the above considerations tend to increase size and weight of the mmWave communication devices.

Further, the range of radio signals decreases with increased frequencies and thus, a larger number of mmWave communication devices (e.g., base stations) are needed for the deployment of the higher frequency radio communication for covering an area, comparing to the deployment of lower frequency radio communications.

Moreover, the ability of radio signals to penetrate solid objects (such as cars, human bodies, trees, and walls) decreases with increased frequencies. For mmWave, communications between two end points normally require a clear line of sight (LOS) without obstruction in between. In other words, the mmWave communication base station must be able to “see” the user equipment (e.g., a smartphone) to enable the mmWave communication. Thus, the mmWave communication device must be installed in a location which is not only close enough to the users but also without any obstructions in between. This is challenging in urban environments and the consequence is that radio equipment has to be hosted (installed) in proximity to where people and traffic reside.

Thus, it would be desirable to provide an improved solution for mmWave communication.

### SUMMARY OF THE INVENTION

It is an object of the present invention to provide a lighting device comprising a wireless communication module for improving the deployment of the higher frequencies radio communication.

According to a first aspect of the invention, this and other objects are achieved by a lighting device comprising a wireless communication module, comprising a wireless communication unit comprising a transmitter and/or a receiver: a feedline configured to connect the transmitter and/or receiver to an antenna for transmitting and/or receiving a radio wave, wherein the feedline comprises a first end configured to connect to the transmitter and/or receiver, and a second end configured to connect to the antenna: a housing enclosing the wireless communication unit, and the first end of the feedline; and a potting material filled in a space defined by the housing, and the wireless communication unit, wherein the wireless communication unit comprises a surface area, wherein the potting material fully encapsulates the wireless communication unit and abuts said surface area; wherein the wireless communication module is configured to be an integral part of a lighting device; wherein the radio wave has a frequency in a range of 6 gigahertz, GHz, to 300 GHz.

The potted wireless communication module has at least the following advantages comparing to the typical mmWave communication device.

Firstly, the internal elements of the potted wireless communication module can be mechanically secured without or at least with less additional fixing means, such as brackets and mechanical mounts.

Secondly, the filled potting material as a protective seal can efficiently seal the wireless communication module to prevent any moisture, water and dust entering the wireless communication module. There is no need for any additional grommets, waterproofing encapsulation housing or sealings.

Thirdly, the filled potting material can provide a mechanical impact protection, such as drop protection, without any additional cushioning materials.

Fourthly, since the filled potting material directly contacts the internal heat sources, it can efficiently transfer heat out to the external environment, e.g., via the housing, without using any heat sinks and/or thermal pads.

Fifthly, the filled potting material can even provide inherent RF and electromagnetic (EM) shielding.

Sixthly, the filled potting material can be applied as a liquid, which subsequently solidifies around the components of the wireless communication module. This enables a simple and cost-effective accommodation of different (versions or generations of) radio equipment within the same housing.

Thus, the filled potting material can replace different elements of the typical mmWave communication device, such that the potted wireless communication module can be made with a reduced number of elements without compromising its performance. Consequently, by removing those heavy and large mechanical elements of the typical mmWave communication device, the potted wireless communication module can be made lighter, smaller and cheaper. In other words, the potted wireless communication module can be made of a reduced number of elements, a reduced size, and a reduced weight.

Further, the small and light potted wireless communication module can be integrated as an integral part of different types of devices, which provides a possibility for improving the incorporation of the higher frequencies radio communication and reducing the incorporation cost. The different types of devices do not necessarily need to relate to wireless communication functions.

It is realized that a lighting system (e.g. an outdoor streetlight system) can be used as a basic infrastructure to deploy higher frequency wireless communications (Wi-Fi, telecommunications 4G/5G, E-band and V-band backhaul), if the potted wireless communication module is an integral part of a lighting device (e.g., a streetlight).

It is advantageous as the streetlight system can offer a proximity to the users, a ubiquitous presence in both cities and suburbs, a suitable granularity as a distance between two neighboring lighting devices matches the mmWave travelling distance, and an elevation to achieve a clear sight to the users and to achieve a large signal coverage.

Further, it is also advantageous as the streetlight system can offer power supply and cable connections for the potted wireless communication module to enable the mmWave communication. It is also advantageous as the potted wireless communication module can be hidden within the lighting device, such that it is entirely invisible or at least less visible.

At least a part of the housing may be made of metal. The metal part of the housing may serve as ground or protective earth for electrical safety reasons, of the wireless communication module.

The housing may be completely made of metal.

The housing may be fully potted with said potting material. Said space may fully surround the wireless communication unit. Said potting material may fully encapsulate the wireless communication unit and/or the first end of the feedline. Hence, the wireless communication unit may comprise a surface area (or: surfaces), wherein the potting material may abut said surface area (or: surfaces).

The housing may comprise a metal mesh. The metal mesh may comprise connected strands of metal. The metal mesh may be woven, knitted, welded, chemically etched, or electroformed from metal. The metal mesh can be a metal web or metal net.

The metal mesh may be embedded in a different material, e.g., a layer of plastic, or be sandwiched between two layers to form the housing. The metal mesh and the different material may be sealed together to create a composite material for housing.

The wireless communication module may further comprise a Global Positioning System, GPS, unit.

The wireless communication unit may comprise at least one printed circuit board assembly, PCBA.

The wireless communication module may further comprise an electrical connector connected to the wireless communication unit, configured to provide a wired connection of data, commands and/or power supply to the wireless communication unit.

The potting material may have at least one of a plurality of functions comprising: a thermal absorption, transport or dissipation function, an electromagnetic, EM, shielding function, an RF shielding function, a weatherproof function, and an impact protection function.

A dielectric constant of the potting material may be equal to or less than 2.5 in a frequency range of 6 GHz to 300 GHz. A dielectric loss tangent of the potting material may be equal to or less than 0.01 in the frequency range of 6 GHz to 300 GHz.

The potting material may comprise any of epoxy, polyurethane, and thermoplastic material such as asphalt.

The housing of the wireless communication module may comprise a fastening element configured to mechanically join the wireless communication module and the lighting device together, such that the wireless communication module becomes an integral part of the lighting device.

The wireless communication module may be integrated within a housing of the lighting device, such that the wireless communication module is literally within the lighting device enclosing by the housing of the lighting device.

However, the housing of the lighting device is not limited to a housing enclosing a main function portion of the lighting device, such as the housing of the light source. For example, the housing may be an outer frame of the lighting device, wherein the outer frame is an integral part of the lighting device.

Alternatively, the housing may be a panel of a lighting device, such as a detachable panel of a lighting device.

The lighting device may further comprise a lighting driver module, comprising: a driver unit configured to power and/or control a lighting device and the wireless communication module, wherein the lighting driver module is configured to be an integral part of the lighting device.

The lighting driver module may comprise a plurality of slots for receiving a plurality of driver units, respectively. The driver unit may be configured to be accommodated within a first slot of the plurality of slots. The wireless communication module may be configured to be accommodated within a second slot of the plurality of slots.

The lighting device may be a streetlight or a light pole.

The lighting device may further comprise the antenna configured to electrically connect to the wireless communication module via the feedline.

At least a part of the housing of the wireless communication module may form a part of a housing of the lighting device.

According to a second aspect of the invention, this and other objects are achieved by a lighting system comprising a plurality of lighting devices.

According to a third aspect of the invention, this and other objects are achieved by a wireless communication module comprising: a wireless communication unit comprising a transmitter and/or a receiver; a feedline configured to connect the transmitter and/or receiver to an antenna for transmitting and/or receiving a radio wave, wherein the feedline comprises a first end configured to connect to the transmitter and/or receiver, and a second end configured to connect to the antenna; a housing enclosing the wireless communication unit, and the first end of the feedline; and a potting material filled in a space defined by the housing, and the wireless communication unit; wherein the wireless communication module is configured to be an integral part of the lighting device, wherein the radio wave has a frequency in a range of 6 gigahertz, GHz, to 300 GHz.

All the features of the first aspect of the invention are applicable to the second and the third aspect.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1A shows a schematic illustration of an example wireless communication module.

FIG. 1B shows a schematic illustration of an example wireless communication unit.

FIG. 2 shows an illustration of an example wireless communication module.

FIG. 3A shows a diagram of an example lighting device comprising the wireless communication module as an integral part.

FIG. 3B shows a top view of an example PCBA.

FIG. 4 shows a schematic illustration of an example lighting driver module.

FIG. 5A shows a schematic illustration of an example lighting device.

FIG. 5B shows a schematic illustration of an example lighting device.

FIG. 6 shows an example lighting system.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

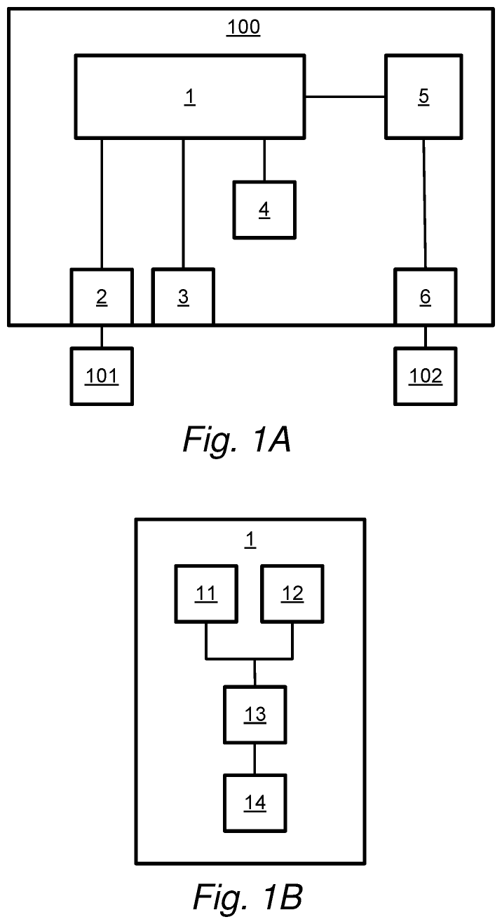

In combination with FIGS. 1A and 1B, an example wireless communication module 100 and an example wireless communication unit 1 will be discussed in detail.

The wireless communication module 100 comprises a wireless communication unit 1 having a transmitter 11 and a receiver 12 for transmitting and receiving a radio signal via an antenna 101. The radio wave preferentially has a frequency in a range of 6 GHz to 300 GHz. The antenna 101 may be an antenna module.

The wireless communication module 100 may be suitable for mmWave communication. In the application, the term “mmWave” refers to any radio wave having a frequency in the range of about 6 GHz to 300 GHz, preferably about 6 GHz to 100 GHz. In other words, a radio wave having frequency less than 6 GHz is not considered to be mmWave in the application.

The wireless communication module 100 may be used for high speed wireless communications, such as 5G communication, and IEEE 80211.ad or 802.11ay standard of Wireless Local Area Network (WLAN).

The wireless communication unit 1 may comprise a power converter (not shown) for performing a power conversion function (DC to DC or AC to DC), e.g., for converting a received power for internal use.

The wireless communication unit 1 may comprise a processor 13, such as a central processing unit (CPU), microcontroller, microprocessor or FPGA.

The wireless communication unit 1 may comprise a memory 14. The memory 14 may be a separate unit, as shown in FIG. 1B, or an integrated part of the processor 13. The memory 14 may store information, such as operation parameters of the wireless communication unit 1, and/or parameters of the transmitter 11 and the receiver 12, and/or operation parameters of the wireless communication module 100.

The memory 14 may be one or more of a buffer, a flash memory, a hard drive, a removable medium, a volatile memory, a non-volatile memory, a random access memory (RAM), or another suitable device. In a typical arrangement, the memory 14 may include a non-volatile memory for long term data storage and a volatile memory that functions as system memory for the wireless communication unit 1. The memory 14 may exchange data with the processor 13 over a data bus. Accompanying control lines and an address bus between the memory 14 and the processor 13 also may be present.

Functions and operations of the wireless communication unit 1 may be embodied in the form of executable logic routines (e.g., lines of code, software programs, etc.) that are stored on a non-transitory computer readable medium (e.g., the memory 14) of the wireless communication unit 1 and are executed by the processor 13. Furthermore, the functions and operations of the wireless communication unit 1 may be a stand-alone software application or form a part of a software application that carries out additional tasks related to the wireless communication unit 1. The described functions and operations may be considered a method that the corresponding device is configured to carry out. Also, while the described functions and operations may be implemented in software, such functionality may as well be carried out via dedicated hardware or firmware, or some combination of hardware, firmware and/or software.

The wireless communication module 100 comprises a feedline 2 configured to connect the transmitter 11 and/or receiver 12 to the antenna or antenna module 101 for transmitting and/or receiving the radio wave. The feedline 2 comprises a first end configured to connect to the transmitter 11 and/or receiver 12 of the wireless communication unit 1. The feedline 2 comprises a second end configured to connect to the antenna or antenna module 101.

The antenna or antenna module 101 may be a passive (non-powered) antenna for a direct RF wave transmission of a signal from the feedline 2. The antenna or antenna module 101 may be an active (powered) radio device for performing functions, such as RF mixing, up-conversion or other frequency shift or changing function, on the signal of the feedline 2 to resulting radio waves.

In case of a passive antenna 101, the feedline 2 may be a cable or a transmission line for connecting the passive antenna 101 with the transmitter 11 and/or receiver 12. The feedline 2 may feed an RF current from the transmitter 11 to the passive antenna 101 for radiating a radio wave. The feedline 2 may transfer an RF voltage induced in the antenna 101 by the radio wave to the receiver 12. Examples of the feedline 2 include a coaxial cable, a twin-lead, a ladder line, a microstrip, and a waveguide.

In case of an active antenna or antenna module 101, the feedline 2 may be a single wire or transmission line carrying combined power from the wireless communication unit 1 to the active antenna or antenna module 101 as well as an RF signal to and from the transmitter 11 and/or receiver 12. In such a case, the feedline 2 may be typically a coaxial cable. The feedline 2 may also comprise a set of physically separated power and RF wires or connections. In this case the RF port of the connection is typically a coaxial cable where the power connection can be a twin lead, or ribbon cable.

The wireless communication module 100 comprises a housing 7 (not shown in FIG. 1A) enclosing the wireless communication unit 1 and the first end of the feedline 2. That is, the feedline 2 comprise at least a portion including the second end that is exposed from the housing such that it can connect to the antenna 101.

When there is a plurality of antennas 101, a plurality of feedlines 2 may be provided for connecting to the plurality of antennas for transmitting and/or receiving radio waves.

The wireless communication module 100 may comprise an electrical connector 3 connected to the wireless communication unit 1. The electrical connector 3 may be configured to provide a wired connection of data, commands and/or power supply to the wireless communication unit 1.

The electrical connector 3 may be configured to receive a wired connection from an external device. The external device may be a lighting device. Examples of the electrical connector 3 include an RJ45 connector, a USB connector, an SFP/SFP+ (Small Form-factor Pluggable) connector, a low voltage DC or AC power supply connector or an AC mains connector.

The wireless communication module 100 may comprise a power supply unit 4 for conversion of AC mains, low voltage AC or DC power, received e.g., via the electrical connector 3, and feed to the wireless communication unit 1. The power supply unit 4 may be connected to both the electrical connector 3 and the wireless communication unit 1.

The power supply unit 4 may be an integral part of the wireless communication unit 1.

The power supply unit 4 of the wireless communication module 100 may comprise an Uninterruptible Power Supply, UPS. An internal UPS may provide a robust operation of the wireless communication module 100 over time even if the external power supply is temporarily off. The power supply unit 4 including the UPS may be provided close to the electrical connector 3 or the wireless communication unit 1.

The wireless communication module 100 may comprise a Global Positioning System (GPS) unit 5. The wireless communication module 100 may comprise a second feedline 6 for connecting the GPS unit 5 to an external GPS antenna 102 for receiving GPS signals, e.g., for calculating a two-dimensional location (latitude and longitude) and a current time. The second feedline 6 may comprise a first end for connecting to the GPS unit 5 and a second end for connecting to the external GPS antenna 102.

The features of the feedline 2 may be analogous applicable to the second feedline 6.

Alternatively, the GPS unit 5 may comprise an integrated GPS antenna for receiving GPS signals. The integrated GPS antenna may be a patch GPS antenna, e.g., mounting on top of a shielding cover of an amplifier of the GPS unit 5.

The connection of the electrical connector 3 with the external device, the connection of the feedline 2 with the antenna 101, and the connection of the second feedline 6 with the external GPS antenna 102 may be sealed.

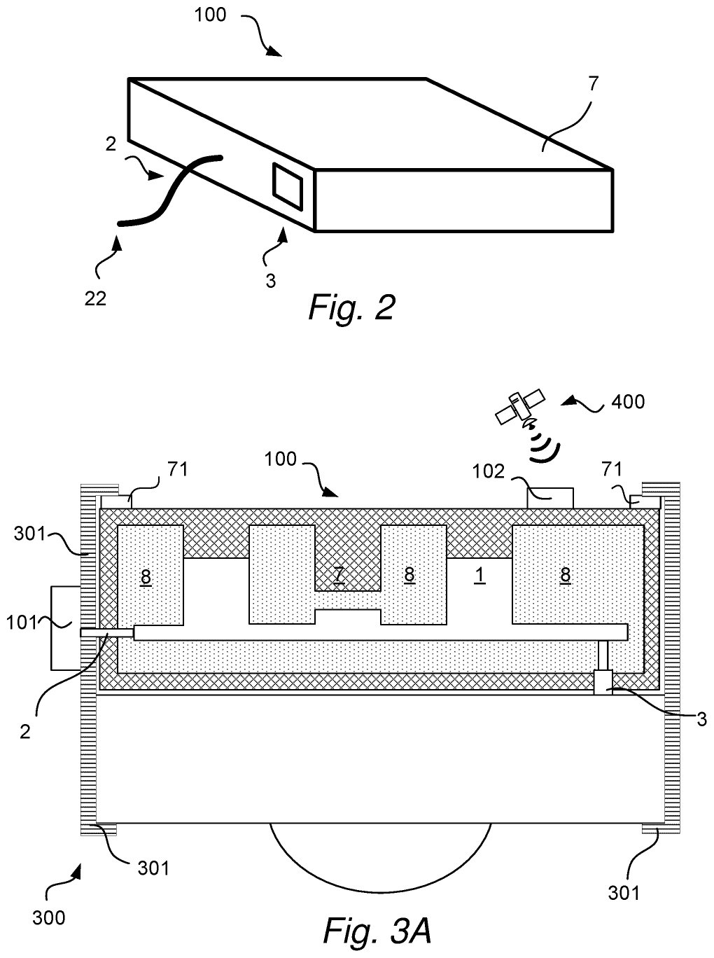

FIG. 2 shows an example wireless communication module 100.

The housing 7 of the wireless communication module 100, or the wireless communication module 100, may have a shape of a substantial rectangular cuboid, as shown in FIG. 2. In other words, the angles between the edges of the housing 7 need not to be right angles, and each pair of faces of the housing 7 needs not to be parallel, etc. The wireless communication module 100 or its housing 7 may have other shapes, such that a substantial hemisphere, a substantial cylinder, or a substantial cone. The exact shape of the housing 7 may be determined based on the lighted device it will be integrated with.

The wireless communication unit 1 may comprise at least one printed circuit board assembly, PCBA. The shape and/or size of the housing 7 may be determined based on the shape and/or size of the PCBA.

The length of an edge of the housing 7 may be tens to hundreds of millimeters. For example, the housing 7 may have a width of about 150 mm, a length of about 200 mm and a thickness of about 50 mm. It is advantageous that the thickness of the housing 7 is smaller than its lengths and width, i.e. the wireless communication module 100 is substantially flat as shown in FIG. 2, such that the wireless communication module 100 can easily fit into different types of lighting devices.

In FIG. 2, the electrical connector 3 and the second end 22 of the feedline 2 for connecting to the antenna or antenna module 101 (not shown) are provided on a same face of the housing 7. However, they may be provided on different faces of the housing 7.

Even though FIG. 2 only shows a single feedline 2, it is understood that there may be a plurality of feedlines 2.

At least a part of the housing 7 may be made of metal. The metal part of the housing 7 may serve as ground (GND) or protective earthing of the wireless communication module 100.

The metal part of the housing 7 may be at least 60%, 70%, 80%, or 90% of a total surface of the housing 7. The housing 7 may comprise a side made of metal.

A part of the housing 7 may be in the form of a metal sheet. A part of the housing 7 may be in the form of a metal mesh. The metal part of the housing 7 may comprise a metal sheet and/or a metal mesh.

The metal mesh may comprise connected strands of metal. The metal mesh may be woven, knitted, welded, chemically etched, or electroformed from metal. The metal mesh can be a metal web or metal net.

The metal mesh may be embedded in a different material, e.g., a layer of plastic, or be sandwiched between two layers. The metal mesh and the different material may be integrated together to create a composite housing material.

The metal mesh can provide the advantages of a metal housing of a metal sheet, including an improved mechanical strength, electromagnetic shielding, etc. Further, by using a metal mesh instead of a metal sheet, a total weight of the wireless communication module 100 can be reduced.

By varying a mesh density, i.e. a hole size of the metal mesh, it is possible to vary the electromagnetic shielding properties of the housing 7. For example, if a mesh hole size is small (e.g. below a half wavelength), the housing 7 made of such metal mesh may effectively block electromagnetic radiations (e.g., radio radiations of the antenna). If the hole size is large (e.g., much larger than a half wavelength), the housing 7 made of such metal mesh cannot effectively block electromagnetic radiation and it may become (partially) “transparent” to electromagnetic radiations. Thus, the metal mesh can provide a more flexible housing 7 for different usages.

The housing 7 may comprise any of a metal mesh and a metal sheet, wherein the metal mesh may have a same or different mesh densities.

The metal part of the housing may have a surface area of at least 100 cm². The metal part may be a single part or a plurality of parts distributed over the surface of the housing 7.

The metal part of the housing 7 may have at least one of a plurality of additional functions comprising: a thermal dissipation function, an electromagnetic (EM) shielding function, and an RF shielding function.

The metal part or metal side of the housing 7 may facilitate dissipating heat of the wireless communication module 100. The metal part or metal side of the housing 7 may be placed close to or surround the internal heat source, such as the processor 13 of the wireless communication unit 1, for better heat dissipation.

The metal part or metal side of the housing 7 may limit the unintentional generation, propagation and reception of electromagnetic energy that may cause unwanted effects such as electromagnetic interference (EMI) or even physical damages of the wireless communication module 100. The metal part or metal side of the housing 7 may be placed close to or surround the transmitter 11 and/or the receiver 12 for better shielding effects.

The housing 7 may be used as a mold in the potting process in addition to acting as a part of the finished wireless communication module 100. This may improve the manufacture of the wireless communication module 100 and reduce the manufacturing cost.

The housing 7 may be made of metal. The metal housing 7 can provide an improved thermal dissipation, and an improved EM and RF shielding of the wireless communication module 100.

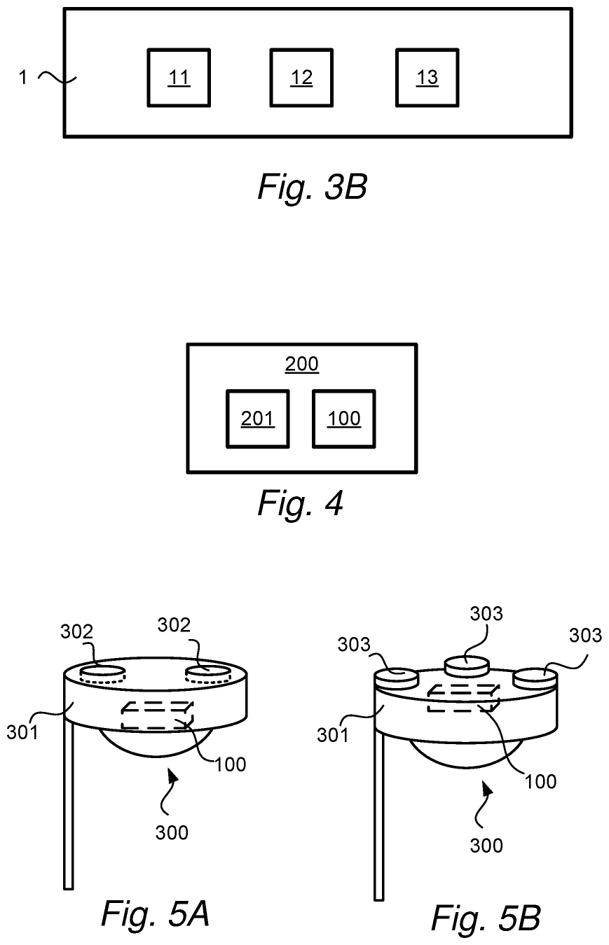

FIG. 3A shows a diagram of an example lighting device 300 comprising the wireless communication module 100 as an integral part. The wireless communication module 100 may be a standard unit for integrating into different types of lighting devices 300. This is advantageous as this may simplify the design of the lighting devices 300. The wireless communication module 100 may not necessarily relate to light functions of the light device 300.

In combination with FIGS. 3A and 3B, the potting material 8 and the lighting device 300 will be discussed in detail.

In the example of FIG. 3A, the wireless communication unit 1 (side view) is represented as a PCBA 1 mechanically supports and electrically connects electronic components placed on a substrate. The PCBA 1 can be single-sided or double-sided. Its substrate may have a single layer or multiple layers.

A top view of the PCBA 1 is illustrated in FIG. 3B. The substrate of the PCBA 1 may be a flat thin layer, and the three protruding portions of the PCBA 1 above the flat thin layer in FIG. 3A may be different electronic components placed on the substrate of the PCBA 1. In the example of FIG. 3B, the three protruding portions of the PCBA 1 are the transmitter 11, the receiver 12 and the processor 13.

The PCBA 1 may comprise a RF section comprising the transmitter 11 and/or the receiver 12. The PCBA 1 may comprise a baseband section. The RF section and the baseband section may be arranged as different PCBAs. The housing 7 may be provided with protrusions to direct contact a portion of the PCBA 1. For example, the metal portion of the housing 7 may contact a GND of the PCBA 1 to enlarge the GND plane area. For example, the metal portion of the housing may contact a non-conductive heat source of the PCBA 1 to improve heat dissipation or transfer.

However, a portion of the housing 7 made of conductive material (e.g., metal) should not direct contact a portion of the PCBA 1 in a way short-circuiting the PCBA 1. Instead, non-conductive material may be placed between the portion of the housing 7 and the portion of the PCBA 1 which are both made of conductive material.

The housing 7 may have an opening for passing through the second end of the feedline 2 for connecting to the antenna or antenna module 101.

The housing 7 may have an opening for exposing the electrical connector 3 for providing a wired connection of data, commands and/or power supply to the wireless communication unit 100.

The opening(s) of the housing 7 may be sealed.

The external GPS antenna 102 may be mounted on an external surface of the housing 7 facing a free space for receiving GPS signals from an GPS satellite 400. The second feedline (not shown) may be provided for connecting the external GPS antenna 102 and the GPS unit 5 (not shown). The connection of the external GPS antenna 102 and the GPS unit 5 may be sealed. When the external GPS antenna 102 is mounted on an external surface of the metal part of the housing 7, the metal part of the housing 7 may act as a reflector for the external GPS antenna 102 for reflecting the GPS signals.

The metal part of the housing 7 may serve as GND of the PCBA 1 and the GPS unit 5.

The size of the GND plane area of a patch GPS antenna may be similar to that of the patch itself. Theoretically, the size of the GND plane area should be infinite. A practical size of the GND plane area should be at least 10 times of the area of the antenna patch. Otherwise, the GPS antenna sensitivity is reduced due to the small GND plane area. Since the metal part of the housing 7 may serve as GND of the wireless communication module 100, including the GPS unit 5, an increased GND plane area may be achieved, and the GPS antenna sensitivity can be improved.

When the wireless communication module 100 is used as an integral part of the lighting device 300, the wireless communication module 100 may be placed in a way such that the external GPS antenna 102 has a free sight facing the sky for receiving the GPS signals from the GPS satellite 400. For example, the wireless communication module 100 may be mounted on top of the lighting device 300, and the GPS antenna 102 may be arranged on top of the wireless communication module 100, as shown in FIG. 3A.

Alternatively or additionally, the GPS antenna may be enclosed within the housing 7 of the wireless communication module 100. The part of the housing 7 covering the GPS antenna may be made in a material allowing the GPS signals to pass through, e.g., plastic or a metal mesh comprising a large hole size, such that the GPS antenna can receive the GPS signals through the housing 7.

If the housing 7 is made of a material blocking the GPS signals, e.g., a metal sheet, the housing 7 may be provided with an opening such that the GPS antenna can receive GPS signals through the opening of the housing 7. The size and form of the opening may be similar to those of the GPS antenna. The opening may be sealed.

The potting material 8 is filled in a space defined by the housing 7 and the wireless communication unit 1 (the PCBA 1). The potting material 8 may have at least one of a plurality of functions comprising a thermal dissipation function, an electromagnetic, EM, shielding function, an RF shielding function, a weatherproof function, and an impact protection function.

A dielectric constant of the potting material 8 may be equal to or less than 2.5 in a frequency range of 6 GHz to 300 GHz. A dielectric loss tangent of the potting material 8 may be equal to or less than 0.01 in the frequency range of 6 GHz to 300 GHz.

Dielectric constant, or relative permittivity, of a material, is defined as the ratio of the electric permeability of the material to the electric permeability of free space, i.e. vacuum. The dielectric constant typically does not vary much within the range of the operating temperature of the wireless communication module 100, e.g., from −40° C. to +50° C. However, the dielectric constant does vary a lot across frequency ranges. That is, the dielectric constant is frequency dependent.

Dielectric loss is used to quantify a dielectric material's inherent dissipation of electromagnetic energy. The dielectric loss tangent is defined as the ratio of the lossy reaction to the electric field in the curl equation to the lossless reaction.

Since the wireless communication unit 1 (the PCBA 1) is normally designed with a presumption that its electronic components contact with air only, covering the PCBA 1 by the potting material, i.e. a dielectric material, may introduce high losses, or even change the functions of the PCBA 1. Thus, by selecting the potting material 8 of a low dielectric constant and a low dielectric loss in the interesting frequency range, e.g., the frequency range of the radio waves that the antenna or antenna module 101 transmits and/or receives, the existing wireless communication unit 1 may function well without any major modifications even if its electronic components contact with the potting material instead of air. This may simplify the design of the wireless communication module 100.

The potting material 8 may comprise any of epoxy, polyurethane, and thermoplastic materials such as asphalt.

Epoxy refers to any of the basic components or cured end products of epoxy resins. The cured epoxy is an electrical insulator and a much better conductor of heat than air.

Since the operating temperature of an outdoor lighting device has a large range, e.g., from −40° C. to +50° C., differences in thermal expansion coefficients between the PCBA 1 and the potting material may cause thermal stresses, which may damage the electronic components of the wireless communication module 100. Since asphalt can soften and even melt when it is heated up, using asphalt as the potting material 8 can reduce a risk of damaging the electronic components of the wireless communication unit 1 (the PCBA 1) due to temperature changes. However, since asphalt may melt when the temperature is high, the housing 7 may be made liquid-proof to prevent melting asphalt from dripping out of the housing 7 and entering the lighting device 300.

Except for the metal part, the remaining part of the housing 7 may be made of the potting material 8 or a different (potting) material.

The housing 7 may comprise a fastening element 71 configured to mechanically join the wireless communication module 100 and the lighting device 300 together, such that the wireless communication module 100 becomes an integral part of the lighting device 300.

The fastening element 71 may comprise a screw, a bolt, a clamp, a grommet, a flange or a rivet.

The fastening element 71 may create non-permanent joints. That is, the wireless communication module 100 can be removed or dismantled from the lighting device 300 without damaging the wireless communication module 100 or the lighting device 300. Thus, the replacement and maintenance of the wireless communication module 100 and the lighting device 300 may be facilitated. Alternatively, the fastening element 71 may create permanent joints.

The housing 7 may comprise a sealing element (not shown) for sealing the connection of the wireless communication module 100 and the lighting device 300. For example, the sealing element may seal the wireless communication module 100 against a housing 301 of the lighting device 300.

The wireless communication module 100 may be entirely enclosed within the lighting device 300.

Alternatively, at least a part of the housing 7 of the wireless communication module 100 may be exposed and may form a part of a housing 301 of the lighting device 300. For example, in FIG. 3A, a top surface of the wireless communication module 100 is exposed to the external environment as a part of the housing 301 of the lighting device 300. Said part of the housing 7 may be made of metal.

This is advantageous as instead of being entirely enclosed by the lighting device's housing 301, the wireless communication module 100 may direct contact with the external environment for heat dissipation. For example, the metal part of the housing of the wireless communication module 100 can be exposed as a part of the housing 301 of the lighting device 300. For example, the PCBA 1 (the wireless communication unit 1) may be arranged in a way such that its heat sources face the part of the housing 7 which is exposed to the external environment.

At least a part of the housing 301 of the lighting device 300 may be made of metal, for transferring and dissipating heat of both the lighting device 300 and the wireless communication module 100.

The lighting device 300 may provide a good thermal contact with the wireless communication module 100 such that the heat dissipation of the wireless communication module 100 can be improved.

The lighting device 300 may comprise a heat sink (not shown) to improve heat transfer and dissipation for the lighting device 300 and/or the wireless communication module 100.

If the metal part of the housing 7 of the wireless communication module 100 is in galvanic contact with a metal part of the housing 301 of the lighting device 300, the GND plane area, e.g., for the GPS antenna 102, can be even larger, and the sensitivity of the GPS antenna 102 can be further improved.

The lighting device 300 may provide a wired connection of data, commands and/or power supply to the PCBA 1 (the wireless communication unit 1), via the electrical connector 3. This is advantageous as the this may simplify the design of the wireless communication module 100. The wireless communication module 100 can be made smaller and lighter.

In combination with FIG. 4, a lighting driver module 200 will be discussed in detail.

The lighting driver module 200 comprises a wireless communication module 100, and a driver unit 201 configured to power and/or control a lighting device 300. The lighting driver module 200 can both control the lighting device 300 and perform mmWave communication.

The lighting device 300 may comprise the lighting driver module 200 as an integral part of the lighting device 300.

The driver unit 200 may be configured for power and/or control a light source of the lighting device 300.

The lighting driver module 200 may be a standard module, which can be readily fit in different types of lighting devices 300.

The lighting driver module 200 may comprise a plurality of slots for receiving a plurality of driver units 201, respectively. The driver unit 201 may be configured to be accommodated within a first slot of the plurality of slots; and the wireless communication module 100 may be configured to be accommodated within a second slot of the plurality of slots.

The wireless communication module 100 may be powered by a separate power supply. That is, the driver unit 201 may not necessarily be used for powering the wireless communication module 100.

The wireless communication module 100 may comprise the internal power supply unit 4 as shown in FIG. 1A, optionally including a power conversion function and/or the UPS. That is, the power supply unit 4 may be an integrated part of the potted wireless communication module 100. Alternatively, the power supply may be provided externally to the potted wireless communication module 100, e.g., the power supply may be provided by the lighting device 300, such that when the lighting driver module 200 or the wireless communication module 100 is joined together with the lighting device 300, the lighting device 300 can power the wireless communication module 100, e.g., via the electrical connector 3.

The lighting driver module 200 may be entirely enclosed by the housing 301 of the lighting device 300. The lighting device 300 may provide a good thermal contact with the lighting driver module 200 such that the heat dissipation of the lighting driver module 200 can be improved.

Alternatively, at least a part of the lighting driver module 200, e.g., a part of the housing 7 of the wireless communication module 100, may expose to the external environment. In other words, said exposed part of the lighting driver module 200 becomes a part of the housing 301 of the lighting device 300. This may improve the heat dissipation of the lighting driver module 200.

The features of the wireless communication module 100 configured to be an integral part of the lighting device 300 may be analogous applicable to the lighting driver module 200. For example, the lighting driver module 200 may comprise a fastening element configured to mechanically join the lighting driver module 200 and the lighting device 300 together, such that lighting driver module 200 becomes an integral part of the lighting device 300.

The wireless communication module 100 may be made of the same form factor as a standard driver unit. The wireless communication module 100 can replace one or multiple standard driver unit(s) of the lighting device 300. Said wireless communication module 100 can fit in the lighting device 300 designed for receiving one or more standard driver units. The wireless communication module 100 can replace a single driver unit of the lighting device. In combination with FIGS. 5A and 5B, the antenna of the lighting device 300 will be discussed in detail.

The lighting device 300 may comprise an antenna 101. The antenna 101 may be an antenna module. The antenna 101 may be configured to electrically connect to the wireless communication module 100 via the feedline 2. The antenna (module) 101 may be an antenna for mmWave communication.

The antenna (module) 101 may be mounted on an external surface of the lighting device's housing 301. The antenna (module) 101 may be an integrated part of the lighting device's housing 301.

In FIG. 5A, a recessed or extended portion 302 is provided on the external surface of the lighting device's housing 301 for accommodating the antenna (module) 101, such that the antenna (module) 101 can be better protected from the external environment. A covering may be provided to cover and seal the recessed portion 302 after the antenna (module) 101 is mounted within the recessed portion 302.

In FIG. 5B, the antenna (module) 101 is enclosed within a separate housing 303 fixed to the external surface of the lighting device's housing 301. The antenna's separate housing 303 may be weatherproofing.

Alternatively or additionally, the antenna (module) 101 may be enclosed within the lighting device's housing 301. In other words, the housing 301 of the lighting device 300 may enclose the antenna (module) 101. The propagation of the radio waves through the housing 301 of the lighting device 300 may be achieved by using a different housing material for at least the part of the housing 301 provided close to the antenna (module) 101 and between the antenna (module) 101 and the free space, e.g., a transparent plastic housing material or a metal mesh having a large hole size, instead of a metal sheet.

In FIGS. 5A and 5B, two and three antenna (module) 101 are provided, respectively. The lighting devices 300 may comprise different numbers of antennas, e.g., one, two, three, or four antennas 101. These antennas may be provided within separate recessed or extended portions of housing of lighting device 300. More than one antenna may be provided within a same recessed or extended portions (302 or 303).

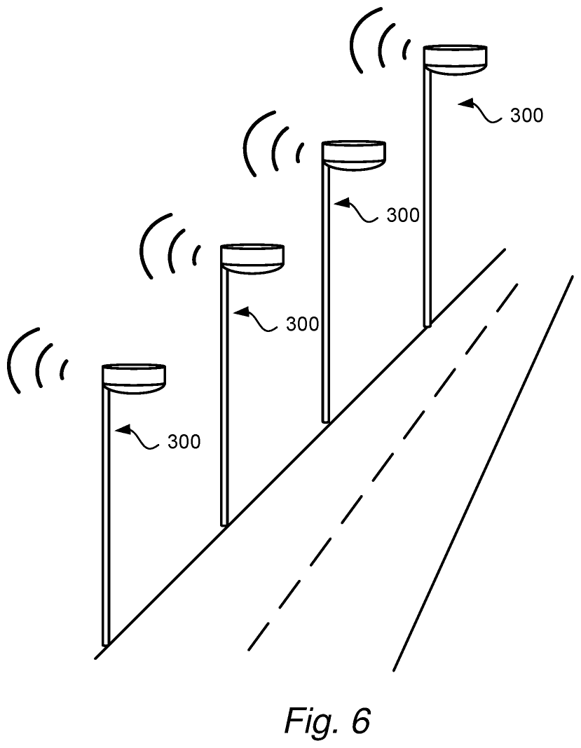

FIG. 6 shows an example lighting system comprising a plurality of lighting devices 300.

The lighting system may be an outdoor streetlight system, as shown in FIG. 6 or an indoor streetlight system, comprising a plurality of streetlights or light poles.

The lighting system can provide a basic infrastructure to deploy mmWave communications. Said lighting system can offer a proximity to the users, which presents widely in both cities and suburbs. Said lighting system has a suitable granularity as a distance between two neighboring lighting devices 300 is smaller than or matches the mmWave travelling distance. Further, said lighting devices 300 provide an elevation to achieve a clear sight to the users and to achieve a large signal coverage for mmWave communication.

Moreover, it is also advantageous as said lighting system can offer power supply and other cable connections to enable the mmWave communication. Additional infrastructures are not needed, which may improve the deployment of the mmWave communication. It is also advantageous as the wireless communication module 100 can be hidden within the lighting devices 300, such that they are less visible or entirely invisible.

In such a lighting system, one wireless communication module 100 can communicate with another wireless communication module 100 to create an integral communication network.

The wireless communication module 100 can connect to other communication devices. For example, a Wi-Fi access point can be connected. Such connection to other (communication) devices can be made via the electrical connector 3 or an additional connector. Alternatively, one wireless communication module 100 can connect to other (communication) devices wirelessly. An access point to the integral communication network may be provided.

The other (communication) device may be a data generating device, such as a sensor device or a camera.

The person skilled in the art realizes that the present invention by no means is limited to the preferred embodiments described above. On the contrary, many modifications and variations are possible within the scope of the appended claims. For example, the wireless communication module may be arranged in many different ways, e.g., the housing may be of different shapes or made of different materials, the lighting device and the wireless communication module may be joined in different ways. Such details are not considered to be an important part of the present invention, which relates to a lighting device comprising a potted wireless communication module having a reduced number of elements, a reduced size, and a reduced weight, as an integral part of a lighting device.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A lighting device comprising a wireless communication module, wherein the wireless communication module comprises:
a wireless communication unit comprising a transmitter and/or a receiver;
a feedline configured to connect the transmitter and/or receiver to an antenna for transmitting and/or receiving a radio wave, wherein the feedline comprises:
a first end configured to connect to the transmitter and/or receiver, and
a second end configured to connect to the antenna;
a housing enclosing the wireless communication unit, and the first end of the feedline; and
a potting material filled in a space defined by the housing, and the wireless communication unit, wherein the wireless communication unit comprises a surface area, wherein the potting material fully encapsulates the wireless communication unit and abuts said surface area;
wherein the wireless communication module is configured to be an integral part of the lighting device;
wherein the radio wave has a frequency in a range of 6 gigahertz, GHz, to 300 GHz.

2. The lighting device according to claim 1,
wherein at least a part of the housing is made of metal, and
wherein the metal part of the housing serves as ground, GND, of the wireless communication module.

3. The lighting device according to claim 1, wherein the housing comprises a metal mesh.

4. The lighting device according to claim 1, wherein the wireless communication module further comprises a Global Positioning System, GPS, unit.

5. The lighting device according to claim 1, wherein the wireless communication module further comprises an electrical connector connected to the wireless communication unit, configured to provide a wired connection of data, commands and/or power supply to the wireless communication unit.

6. The lighting device according to claim 1, wherein the potting material has at least one of a plurality of functions comprising:
a thermal absorption, transport, or dissipation function,
an electromagnetic, EM, shielding function,
a RF shielding function,
a weatherproof function, and
an impact protection function.

7. The lighting device according to claim 1, wherein a dielectric constant of the potting material is equal to or less than 2.5 in a frequency range of 6 GHz to 300 GHz, and a dielectric loss tangent of the potting material is equal to or less than 0.01 in the frequency range of 6 GHz to 300 GHz; or
wherein the potting material comprises any of epoxy, polyurethane, or thermoplastic material such as asphalt.

8. The lighting device according to claim 1, wherein the housing comprises a fastening element configured to mechanically join the wireless communication module and the lighting device together, such that the wireless communication module becomes an integral part of the lighting device.

9. The lighting device according to claim 1, further comprising a lighting driver module, comprising:
a driver unit configured to power and/or control the lighting device; and
the wireless communication module;
wherein the lighting driver module is configured to be an integral part of the lighting device.

10. The lighting device according to claim 9, wherein the lighting driver module comprises a plurality of slots for receiving a plurality of driver units, respectively,
wherein the driver unit is configured to be accommodated within a first slot of the plurality of slots; and
wherein the wireless communication module is configured to be accommodated within a second slot of the plurality of slots.

11. The lighting device according to claim 1 is a streetlight or a light pole.

12. The lighting device according to claim 1, further comprising the antenna configured to electrically connect to the wireless communication module via the feedline.

13. The lighting device according to claim 1, wherein at least a part of the housing of the wireless communication module forms a part of a housing of the lighting device.

14. A lighting system comprising a plurality of lighting devices according to claim 1.

15. A wireless communication module comprising:
a wireless communication unit comprising a transmitter and/or a receiver;
a feedline configured to connect the transmitter and/or receiver to an antenna for transmitting and/or receiving a radio wave, wherein the feedline comprises
a first end configured to connect to the transmitter and/or receiver, and
a second end configured to connect to the antenna;
a housing enclosing the wireless communication unit, and the first end of the feedline; and
a potting material filled in a space defined by the housing, and the wireless communication unit, wherein the wireless communication unit comprises a surface area, wherein the potting material fully encapsulates the wireless communication unit and abuts said surface area;
wherein the wireless communication module is configured to be an integral part of the lighting device according to claim 1;
wherein the radio wave has a frequency in a range of 6 gigahertz, GHz, to 300 GHz.
